(19) United States
(12) Patent Application Publication
(10) Pub. No.: US 2010/0153255 A1
(43) Pub. Date: Jun. 17, 2010

(54) METHODS AND SYSTEMS RELATING TO FUTURES TRADING

(76) Inventor: James Tyler, London (GB)

Correspondence Address: BERENATO & WHITE, LLC, 6550 ROCK SPRING DRIVE, SUITE 240, BETHESDA, MD, 20817, US

(21) Appl. No.: 12/600,743

(22) PCT Filed: Mar. 31, 2008
(86) PCT No.: PCT/GB08/01110

§ 371 Date: Nov. 18, 2009

(30) Foreign Application Priority Data
May 18, 2007 (GB) 0709610.0

(51) Int. Cl. G06Q 40/00

(52) U.S. Cl. 705/37

(57) ABSTRACT

A method for converting a trading position is expressed in terms of futures contracts into a trading position expressed in terms of at least butterflies of futures contracts. The method comprises: providing a trading position; for the earliest maturity date t₁, converting the trading position into an interim trading position by subtracting n(t₁) contracts associated with maturity date t₁, −2n(t₁) contracts associated with maturity date t₂ and n(t₁) contracts associated with maturity date t₃, the total number of futures contracts subtracted together being equivalent to n(t₁) butterflies associated with maturity dates t₁, t₂ and t₃; repeating the step for maturity dates t₂ to tₘ₋₂, wherein each step converts the previous interim trading position into a new interim trading position, and each step comprises subtracting a number n(t) of butterflies; extracting the number of butterflies subtracted, from the results to give a trading position expressed in terms of butterflies.

### FIELD OF THE INVENTION

The invention relates to a method and apparatus for converting between, in both directions, a trading position expressed in terms of futures contracts and a trading position expressed in terms of butterflies of futures contracts. The invention also relates to a method for providing information to a trader using one or more converted trading positions.

### BACKGROUND OF THE INVENTION

This application relates to the trading of futures contracts and the provision of a useful tool for trading analysis. A futures contract is a standardised contract to buy or sell a certain underlying instrument at a certain date in the future at a specified price. A futures contract is a type of derivative.

The examples given in this application mainly relate to Short Term Interest Rate Futures (STIRs), although the tool could equally apply to any futures contract. Interest Rate Futures are exchange-traded forward rate agreements with standard contract sizes and maturity dates which are cash-settled on a daily basis throughout the life of the contract.

Short- and long-term interest rate futures contracts are traded on exchanges worldwide. Some of the more important short-term contracts traded on the Chicago Mercantile Exchange (CME) are the three-month Eurodollar (short-term, with unit of trading of US$ 1,000,000), the one-month LIBOR (short-term, with unit of trading of US $3,000,000), one year T-bills (short-term, with unit of trading of US $500,000), the three month Euroyen (short-term, with unit of trading of JPY 100,000,000) and 13-week US T-bills (short-term, with unit of trading of US $1,000,000—this contract is for physical delivery). Two long-term contracts traded on the CME are US T-bonds (nominal value US $100,000, maturity range at least 15 years) and 10 year US T-notes (nominal value US $100,000, maturity range between 6.5 and 10 year).

Some of the more important short-term contracts traded on the London International Financial Futures and Options Exchange (LIFFE) are the three-month Sterling LIBOR (known as Short Sterling, short-term, with unit of trading of GB£ 500,000), the three-month Euroswiss Franc (known as Euroswiss, short-term, with unit of trading of CHF 1,000,000), and the three-month Euribor (short-term, with unit of trading of Euro 1,000,000).

The examples given below will concern Short Sterling which is traded on the LIFFE. However, the invention equally applies to other futures contracts. The unit of trading (i.e. the standard contract size) is GB£ 500,000. The delivery months are March, June, September and December. The day the contract is settled (the Delivery Day) is the first business day after the last trading day. The last trading day i.e. the last day and time on which trading can take place, is 11.00 on the third Wednesday of the delivery month. The minimum price movement (this is the smallest amount a contract can change value—the tick size) is 0.01 i.e. £12.50: 0.01 of the unit of trading is £50. This is divided into four three-month periods (December to March, March to June, June to September, September to December) giving £12.50 as the tick size. Alternatively, we could describe the Sterling tick as reflecting the value of a 1/100 of one percent change in a £500,000, 90-day contract, i.e. 0.01% * £500,000 * 90/360=£12.50

Another example of futures contracts to which the invention might be applied are futures contracts in the energy markets (including: crude oil, gasoline, heating oil, natural gas, coal and propane). Contracts here usually have one-month gaps between contracts, and represent a single delivery of the underlying product. Other examples are commodities (‘softs’ such as meats, butter, orange juice, soybeans, grains, cocoa, coffee, sugar; metals such as gold, copper aluminium, zinc), foreign currencies (Euros, Dollars, Sterling, Yen, Swiss Franc etc), equities (stocks and shares), government and corporate bonds. Note that there are over 75 futures exchanges and hundreds of futures products.

Various terminology will be used throughout this description. For clarification, this will now be explained. Prices are separated into two categories: directional (outright) contracts and contiguous (spread) strategies. A “+” indicates the item is being bought i.e. credit and a “−” indicates the item is being sold i.e. a debit. An outright is a single traded contract, for example the December 2008 Short Sterling contract. If one of these contracts is bought, the position is shown as +1 Dec'08. On the other hand, if we sell, we have −1 Dec'08.

A strategy is a combination of outrights which fixes one outright against an exact inverse quantity of a second outright, for example the December 2008 March 2009 quarterly (3-month spread). This simply means to buy a Dec'08 outright and sell a Mar'09 outright. The spread is referred to as +1 Dec'08Mar'09, which is equal to +1 Dec'08 and −1 Mar'09.

Other spread strategies include 6-month, 9-month and one-year spreads, or indeed any other combination of 3 month outrights. For example, the Mar'08Sep'08 spread is equal to +1 Mar'08 and −1 Sep'08.

Further strategies are available. For example, butterflies fix one spread against another spread, for example the December 2008 March 2009 spread (Dec'08Mar'09) against the March 2009 June 2009 spread (Mar'09June'09). +1 Dec'08Mar'09June'09 butterfly is equal to +1 Dec'08Mar'09 and −1 Mar'09June'09, which is, in turn, equal to +1 Dec'08, −2 Mar'09, +1 June'09. (In fact, this +1, −2, +1 pattern is easily recognised as a butterfly position.)

Other traded strategies include spread-of-flies (fixes one butterfly against another), fly-of-flies (fixes one spread-of-fly against another), packs (fixes one outright against the exact quantity (not inversed) of four preceding outright contracts, made up of all four contracts in each twelve-month period e.g. −1 Mar'08, −1 June'08, −1 Sep'08, −1 Dec'08), bundles (made up of two or more packs in order, e.g. buy one of each of the first 8 (12 or 16 etc) outright contracts); strips (similar to a pack but for any amount of outright contracts), condors (fixes one outright against an exact inverse quantity of two second proceeding outrights and the exact (non-inverse) quantity of a fourth outright, e.g. +1 Mar'08, −1 June'08, −1 Sep'08, +1 Dec'08: this is like a fly across four contracts instead of three) and so on.

A trader may trade any combination of outrights, spreads, butterflies and so on. Outrights tend to change in price quickly, whereas spreads move more slowly and butterflies more slowly still. Therefore, a trader can choose exactly what to trade based on a particular trading strategy. Given this, it is very useful for the trader to be able to convert between positions of outrights, positions of spreads and positions of butterflies, so that he/she knows what he/she needs to buy or sell. For example, he may wish to convert an outright position (either a desired position or an existing position) into a position in terms of butterflies. Then, if he is trading butterflies, he will know how to reach his required outright position. Alternatively, he may know the position in terms of butterflies, but need to know what he needs to trade in terms of outrights in order to reach that position. Or, he may have a current position but want to reach a particular position, for example by the close of trading on a particular day, and he will need to know what he needs to buy or sell to reach the required close of trading position.

### SUMMARY OF THE INVENTION

According to a first aspect of the invention, there is provided a method for converting a trading position expressed in terms of futures contracts, each futures contract being associated with a maturity date, into a trading position expressed in terms of at least butterflies of futures contracts, each butterfly being associated with three maturity dates, the method comprising the steps of: a) providing a trading position, expressed in terms of futures contracts, each futures contract being associated with a maturity date t, the trading position comprising n(t) contracts for each of m maturity dates, t₁ to tₘ, n being positive for futures contracts purchased and negative for futures contracts sold; b) for the earliest maturity date t₁, converting the trading position into an interim trading position by subtracting n(t₁) contracts associated with maturity date t₁, −2n(t₁) contracts associated with maturity date t₂ and n(t₁) contracts associated with maturity date t₃, the total number of futures contracts subtracted together being equivalent to n(t₁) butterflies associated with maturity dates t₁, t₂ and t₃; c) repeating step b) for maturity dates t₂ to tₘ₋₂, wherein each converting step b) converts the previous interim trading position into a new interim trading position, and each converting step b) comprises subtracting a number n(t) of butterflies; d) extracting the number of butterflies subtracted, from the results at b) and c), to give a trading position expressed in terms of butterflies.

Thus, the futures contracts trading position is converted into a butterfly trading position, which may be more useful to the trader. Note that the trading position may be an actual trading position held by the trader or a required trading position desired by the trader. The trading position expressed in terms of futures contracts may be entered by a trader into a system, using an input device. The trading position expressed in terms of at least butterflies of futures contracts may be displayed to the trader on a user interface.

In one embodiment, if the trading position expressed in terms of futures contracts comprises a non-zero total number of futures contracts

$${\sum }_{{t}_{1}}^{{t}_{m}} n ( t ) ,$$

the method further comprises an initial step of subtracting the appropriate number of futures contracts to produce a contract-adjusted trading position expressed in terms of futures contracts, the contract-adjusted trading position having a total number of futures contracts

$${\sum }_{{t}_{1}}^{{t}_{m}} n ( t )$$

equal to zero. If the trading position has a net non-zero total, this means that there must be some futures contracts which do not form part of a butterfly or part of a spread. In this embodiment, they are deducted at the outset and the steps of the method use the resulting adjusted trading position for the conversion to a trading position in terms of butterflies.

In that case, the number of futures contracts subtracted from the trading position to produce the contract-adjusted trading position may be included in the trading position expressed in terms of at least butterflies, as an additional number of futures contracts.

The futures contracts can be subtracted from the number n(t) of futures contracts associated with any one or more maturity dates. A choice can be made as to which maturity date or dates to subtract from. In one embodiment, the subtraction is made manually by the trader, who selects from which n(t) to subtract. The trader may run the calculator several times and compare results when the subtraction is made from one or more n(t)'s of different maturity dates t. In an alternative embodiment, the subtraction is made automatically from the most recently traded futures contracts, until the resulting adjusted trading position has a total number of futures contracts equal to zero. Or a combination of the two systems may be used: for example, the trader first manually adjusts and then, when the trader is happy with the manual adjustment, an automatic adjustment is made to give a total number of futures contracts equal to zero.

Preferably, the method further comprises the step of: e) adjusting the trading position expressed in terms of butterflies derived at step d), to produce a spread-adjusted trading position, using the number n(tₘ₋₁) of futures contracts associated with maturity date tₘ₋₁ in the interim trading position derived from the final repetition of step b) in accordance with step c).

In one embodiment, the trading position expressed in terms of butterflies derived at step d) comprises n_{b}(t) butterflies for each set of three consecutive maturity dates t₁t₂t₃ . . . tₘ₋₂tₘ₋₁tₘ and step e) of adjusting the trading position may comprise comparing the number n(tₘ₋₁) with each number of butterflies n_{b}(t) and, if n(tₘ₋₁) is equal to n_{b}(t), subtracting n(tₘ₋₁) from n_{b}(t) and, if n(tₘ₋₁) is not equal to n_{b}(t), making no adjustment to n_{b}(t).

The step of comparing the number n(tₘ₋₁) with each number of butterflies n_{b}(t) preferably comprises: comparing n(tₘ₋₁) with n_{b}(tₘ₋₂,tₘ₋₁,tₘ), then comparing n(tₘ₋₁) with n_{b}(tₘ₋₃,tₘ₋₂,tₘ₋₁) and so on until the step of comparing n(tₘ₋₁) with n_{b}(t₁,t₂,t₃).

The number n(tₘ₋₁) of futures contracts associated with maturity date tₘ₋₁ in the interim trading position derived from the final repetition of step b) in accordance with step c), may be included in the trading position expressed in terms of at least butterflies, as an additional number of spreads of futures contracts.

According to the first aspect of the invention, there is also provided a method for converting a trading position expressed in terms of futures contracts, each futures contract being associated with a maturity date, into a trading position expressed in terms of butterflies of futures contracts, spreads of futures contracts and futures contracts, each butterfly being associated with three maturity dates and each spread being associated with two maturity dates, the method comprising the steps of: a) providing a trading position, expressed in terms of futures contracts, each futures contract being associated with a maturity date t, the trading position comprising n(t) contracts for each of m maturity dates, t₁ to tₘ, n being positive for futures contracts purchased and negative for futures contracts sold; b) if the total number of futures contracts

$${\sum }_{{t}_{1}}^{{t}_{m}} n ( t )$$

in the trading position at a) is not equal to zero, subtracting the appropriate number of futures contracts from the trading position to produce a contract-adjusted trading position, the adjusted trading position having a total number of futures contracts

$${\sum }_{{t}_{1}}^{{t}_{m}} n ( t )$$

equal to zero; c) for the earliest maturity date t₁, converting the contract-adjusted trading position into an interim trading position by subtracting n(t₁) contracts associated with maturity date t₁, −2n(t₁) contracts associated with maturity date t₂ and n(t₁) contracts associated with maturity date t₃, the total number of futures contracts subtracted together being equivalent to n(t₁) butterflies associated with maturity dates t₁, t₂ and t₃; d) repeating step c) for maturity dates t₂ to tₘ₋₂, wherein each converting step c) adjusts the previous interim trading position into a new interim trading position, and each converting step c) comprises subtracting a number n(t) of butterflies; e) extracting the number of butterflies subtracted, from the results at c) and d) to give a trading position expressed in terms of butterflies; f) adjusting the trading position expressed in terms of butterflies derived at step e) to take account of spreads of futures contracts not included in a butterfly; and g) deriving a trading position expressed in terms of butterflies of futures contracts, spreads of futures contracts and futures contracts from the number of butterflies in the adjusted trading position of step f), the number of spreads accounted for in step f) and the number of futures contracts accounted for in step b).

According to a second aspect of the invention, there is provided a method for converting a trading position expressed in terms of butterflies of futures contracts, each butterfly being associated with three maturity dates, into a trading position expressed in terms of futures contracts, each futures contracts being associated with a maturity date, the method comprising the steps of: a) providing a trading position, expressed in terms of butterflies of futures contracts, each butterfly being associated with a first maturity date in the range t₁ to tₘ₋₂, a second maturity date in the range t₂ to tₘ₋₁ and a third maturity date in the range t₃ to tₘ, the trading position comprising n(t) butterflies for each first maturity date t₁ to tₘ₋₂, n being positive for butterflies purchased and negative for butterflies sold; b) for the earliest first maturity date t₁, calculating the number of futures contracts equivalent to n(t₁) butterflies, wherein n(t₁) butterflies is equivalent to n(t₁) futures contracts associated with maturity date t₁, −2n(t₁) futures contracts associated with maturity date t₂ and n(t₁) futures contracts associated with maturity date t₃; c) repeating step b) for first maturity dates t₂ to tₘ₋₂; and d) summing the number of futures contracts for each maturity date derived from steps b) and c) to give a trading position expressed in terms of futures contracts.

Thus, the butterflies trading position is converted into a futures contracts position, which may be more useful to the trader. Note that the trading position may be an actual trading position held by the trader or a required trading position desired by the trader. The trading position expressed in terms of butterflies of futures contracts may be entered by a trader into a system, using an input device. The trading position expressed in terms of futures contracts may be displayed to the trader on a user interface.

According to a third aspect of the invention, there is provided a method of providing information to a trader, the method comprising the steps of: a) converting a current trading position expressed in terms of futures contracts into a current trading position expressed in terms of at least butterflies of futures contracts, according to the method of the first aspect of the invention; b) comparing the current trading position derived at step a) with a required trading position expressed in terms of butterflies of futures contracts; and c) indicating to the trader the purchases and sales of butterflies of futures contracts and/or spreads of futures contracts and/or futures contracts, needed to turn the current trading position into the required trading position.

According to the third aspect of the invention, there is also provided a method of providing information to a trader, the method comprising the steps of: a) converting a required trading position expressed in terms of futures contracts into a required trading position expressed in terms of at least butterflies of futures contracts, according to the method of the first aspect of the invention; b) comparing the required trading position derived at step a) with a current trading position expressed in terms of butterflies of futures contracts; and c) indicating to the trader the purchases and sales of butterflies of futures contracts and/or spreads of futures contracts and/or futures contracts, needed to turn the current trading position into the required trading position.

According to the third aspect of the invention, there is also provided a method of providing information to a trader, the method comprising the steps of: a) converting a current trading position expressed in terms of butterflies of futures contracts into a current trading position expressed in terms of futures contracts, according to the method of the second aspect of the invention; b) comparing the current trading position derived at step a) with a required trading position expressed in terms of futures contracts; and c) indicating to the trader the purchases and sales of futures contracts, needed to turn the current trading position into the required trading position.

According to the third aspect of the invention, there is also provided a method of providing information to a trader, the method comprising the steps of: a) converting a required trading position expressed in terms of butterflies of futures contracts into a required trading position expressed in terms of futures contracts, according to the method of the second aspect of the invention; b) comparing the required trading position derived at step a) with a current trading position expressed in terms of futures contracts; and c) indicating to the trader the purchases and sales of futures contracts, needed to turn the current trading position into the required trading position.

The current trading position expressed in terms of futures contracts or in terms of butterflies may be entered by a trader into a system, using an input device. The required trading position expressed in terms of butterflies or futures contracts may be entered by a trader into a system, using an input device.

Step c) of the method may comprise displaying information to the trader on a trader user interface. Any number of pieces of information may be displayed to the trader along with the indication of the purchases and sales of butterflies of futures contracts and/or spreads of futures contracts and/or futures contracts, needed to turn the current trading position into the required trading position. One or more of the following may be displayed: the current trading position expressed in terms of futures contracts; the current trading position expressed in terms of at least butterflies of futures contracts; the required trading position expressed in terms of butterflies of futures contracts; the required trading position expressed in terms of futures contracts.

There is also provided apparatus specially adapted to carry out the method of any of the aspects of the invention.

There is also provided a computer program which, when run on computer means, causes the computer means to carry out the method of any of the aspects of the invention.

There is also provided a record carrier having stored thereon a computer program which, when run on computer means, causes the computer means to carry out the method of any of the aspects of the invention.

Features described in relation to one aspect of the invention may also be applicable to other aspects of the invention.

### BRIEF DESCRIPTION OF THE DRAWINGS

Exemplary embodiments of the invention will now be described with reference to the accompanying drawings, of which:

FIG. 1 shows an embodiment of a calculator of the first aspect of the invention;

FIG. 2 shows the calculator of FIG. 1 used to solve a simple outright position;

FIG. 3a shows the calculator of FIG. 1 used correctly to solve a simple spread position;

FIG. 3b shows the calculator of FIG. 1 used incorrectly with the simple spread position used in FIG. 3a;

FIG. 4 shows the calculator of FIG. 1 used to solve a position of two spreads, giving a multiple fly position;

FIG. 5 shows the calculator of FIG. 1 used to solve a position of two spreads, giving a multiple fly position and left over spread;

FIG. 6 shows the calculator of FIG. 1 again used to solve a position of two spreads, giving a multiple fly position and left over spread;

FIG. 7 shows the calculator of FIG. 1 again used to solve a position of two spreads, giving a multiple fly position and left over spread;

FIG. 8 shows an embodiment of a calculator of the second aspect of the invention used to solve a simple fly position;

FIG. 9 shows the calculator of FIG. 8 used to solve a spread of fly position;

FIG. 10 shows the calculator of FIG. 8 used to solve a fly of fly position;

FIG. 11 shows the calculator of FIG. 8 used to solve a complex butterfly position;

FIG. 12 shows the steps used in one example of using the automatic and manual fly calculators in practice; and

FIG. 13 shows the presentation of information to a trader for one example.

### DETAILED DESCRIPTION OF A PREFERRED EMBODIMENT

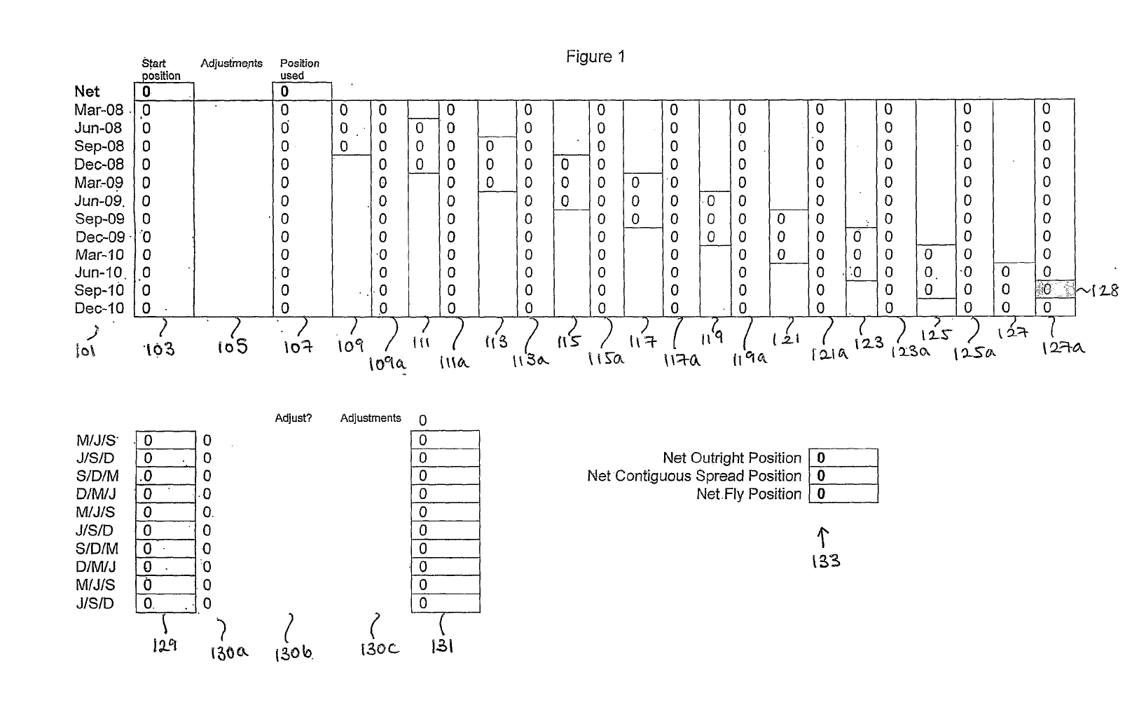

As already described, a first aspect of the invention provides a method for resolving a position of outrights and strategies into a position of outrights, spreads and butterflies. This is referred to as the Automatic Fly Calculator. (‘Fly’ is simply a shortening of the term ‘Butterfly’.) An embodiment of the first aspect invention will now be described with reference to FIGS. 1 to 7.

Firstly, let's consider several simple examples. If the trader's position (or required position) is simply:

| | | |
|---|---|---|
| Mar '08 | +1 | [1] |

this is easily resolved into a single outright of +1 Mar'08.

Similarly, if the trader's position (or required position) is:

| | | |
|---|---|---|
| Mar '08 | +1 | |
| June '08 | −1 | [2] |

this is, fairly clearly, a simple buy of a Mar'08June'08 spread i.e. the trader has bought (or requires to buy) 1 Mar'08 outright but sold 1 June'08 outright.

Again, if the trader's position, or required position, is:

| | | |
|---|---|---|
| Mar '08 | +1 | |
| June '08 | −1 | |
| Sep '08 | +1 | |
| Dec '08 | −1 | [3] |

this can be seen to be a buy of a 1 Mar'08June'08 spread and a buy of a 1 Sep'08Dec'08 spread.

If the trader's position is:

| | | |
|---|---|---|
| Mar '08 | +1 | |
| June '08 | −2 | |
| Sep '08 | +1 | |
| Dec '08 | +1 | [4] |

this can be seen to be a buy of a 1 Mar'08June'08Sep'08 butterfly and a buy of a 1 Dec'08 outright.

The above positions [1] to [4] are simple and it is easy to immediately resolve them into outright, spread and butterfly positions. Thus, if the trader wants his resulting position to be any of positions [1] to [4], he knows what he has to buy and/or sell to reach that position.

However, most positions (either actual or desired) are considerably more complicated than any of positions [1] to [4] above. For example, consider the position:

| | | |
|---|---|---|
| Mar '08 | +50 | |
| June '08 | −83 | |
| Sep '08 | +20 | |
| Dec '08 | +110 | |
| Mar '09 | −16 | [5] |

This is not easy to resolve into a simple outright, spread, butterfly position but it can be resolved using the automatic fly calculator of the first aspect of the invention.

FIG. 1 shows a first embodiment of the invention, which could be used to solve a complicated trading position like position [5] above.

The possible outrights are listed in column 101; in this example, the outright maturity dates extend from Mar'08 to Dec'10. The number of each of those outrights bought or sold is listed in column 103. Note that, because no trading position has yet been entered, there are no figures listed in column 103. Outright adjustments (to be explained below) are listed in column 105 and the resulting position (taking account of those adjustments) is given in column 107.

The calculator shown in FIG. 1 starts from the earliest outright (in this case Mar'08) and resolves the trading position into a number of butterflies, extending from the earliest maturity date outright i.e. in this case the Mar'08June'08Sep'08 butterfly, to the latest maturity date outright i.e. in this case the June'10Sep'10Dec'10 butterfly, plus a number of left over spreads and a number of left over outrights.

Thus, in FIG. 1, column 109 shows the number of resulting Mar'08June'08Sep'08 butterflies. Column 109a shows the resolved position after taking into account the column 109 butterflies. Similarly, column 111 shows the number of resulting June'08Sep'08Dec'08 butterflies and column 111a shows the resolved position after taking into account the column 111 butterflies, and so on until column 127 shows the number of resulting June'10Sep'10Dec'10 butterflies and column 127a shows the resolved position after taking into account the column 127 butterflies. Table 129 shows a summary of the butterfly positions shown in columns 109, 111, 113, 115, 117, 119, 121, 123, 125 and 127.

In this example, there are ten butterflies extending from Mar'08June'08Sep'08 to June'10Sep'10Dec'10, but, clearly, the number of columns and hence the number of rows in the table 129 would depend on the earliest and latest maturity dates listed in column 101.

Columns 130a, 130b and 130c show adjustments to be made to the trading position of table 129 and will be discussed further below.

Column 131 shows the trading position of table 129, adjusted to take account of outstanding (left over) spreads according to columns 130a, 130b and 130c. The adjustment is based on the figure at location 128. Table 133 lists the total correct net position produced by the Automatic Fly Calculator in terms of Net Outright Position, Net Contiguous Spread Position and Net Fly Position.

As discussed above, column 105 is used to make adjustments to the position given in column 103. This is used to account for outstanding outrights in the position, as will now be explained.

For a simple spread, for example position [2] above, the number of “+” outrights (i.e. bought outrights) is always equal to the number of “−” outrights (i.e. sold outrights). Thus, the total net position is zero. In position [2], (+1)+(−1)=0. Similarly, for a simple butterfly, the number of bought outrights is equal to the number of sold outrights, so the total net position is zero. See, for example, the Mar'08, June'08 and Sep'08 entries in position [4]: (+1)+(−2)+(+1)=0. So, for any position which does not have a net position of zero, there must be some outstanding outrights which are not incorporated into a spread or a butterfly. For example, in position [4], the total net position is +1 outright and this is because we have +1 Dec'08 outright.

In the embodiment shown in FIG. 1, the position used for the calculation (i.e. column 107) must have a net total position of zero, so we use column 105 to appropriately adjust the actual position in column 103 to give us a net position of zero in column 107. How this is done, is discussed in more detail below.

Once we have obtained the net zero position in column 107, we can resolve the position into butterflies. For example, if we have +x Mar'08 outrights in our column 107 position, this means we convert this into +x Mar'08June'08Sep'08 butterflies i.e. +x Mar'08, −2x June'08 and +x Sep'08. Note that +x Mar'08 cannot simply be translated into x butterflies; to complete the butterfly position, we need to sell 2x June'08 and also buy x Sep'08. We enter this (+x Mar'08, −2x Jun'08, +x Sep'08) in column 109. Column 109a is the new position taking into account the butterfly of column 109 and we will see that the resulting Mar'08 number is zero (+x−x=0).

Then, if we have, for example, −y June'08 outrights in column 109a (i.e. −y June'08 after taking into account the original number of June'08 in column 107 and the additional number of June'08 in column 109 (in the above example −2x) to take account of the Mar'08 outrights), this means we must have −y June'08Sep'08Dec'08 butterflies in column 111 i.e. −y June'08, +2y Sep'08 and −y Dec'08. Column 111a is the new position taking into account the butterfly of column 111 and we will see that the June'08 number is zero. We continue to perform these steps through the columns 113 to 127, and the resulting positions are listed in table 129.

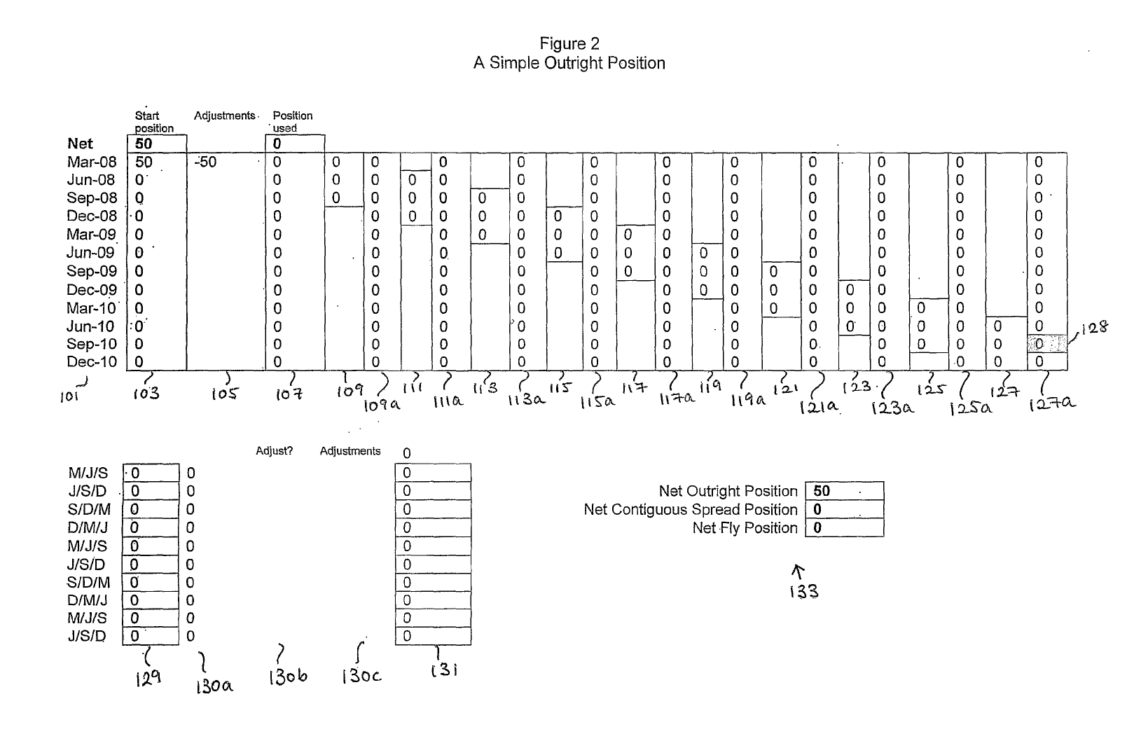

FIG. 2 shows the calculator used to resolve a simple outright position. In the FIG. 2 example, the column 103 position is simply +50 Mar'08 outrights. Clearly, this does not have a net zero position, so we make an adjustment of −50 Mar'08 outrights in column 105. This gives us a resulting position in column 107 of zero. Thus, there are no butterflies listed in columns 109 to 127, table 129 is empty and there is simply +50 listed as the Net Outright Position in table 133.

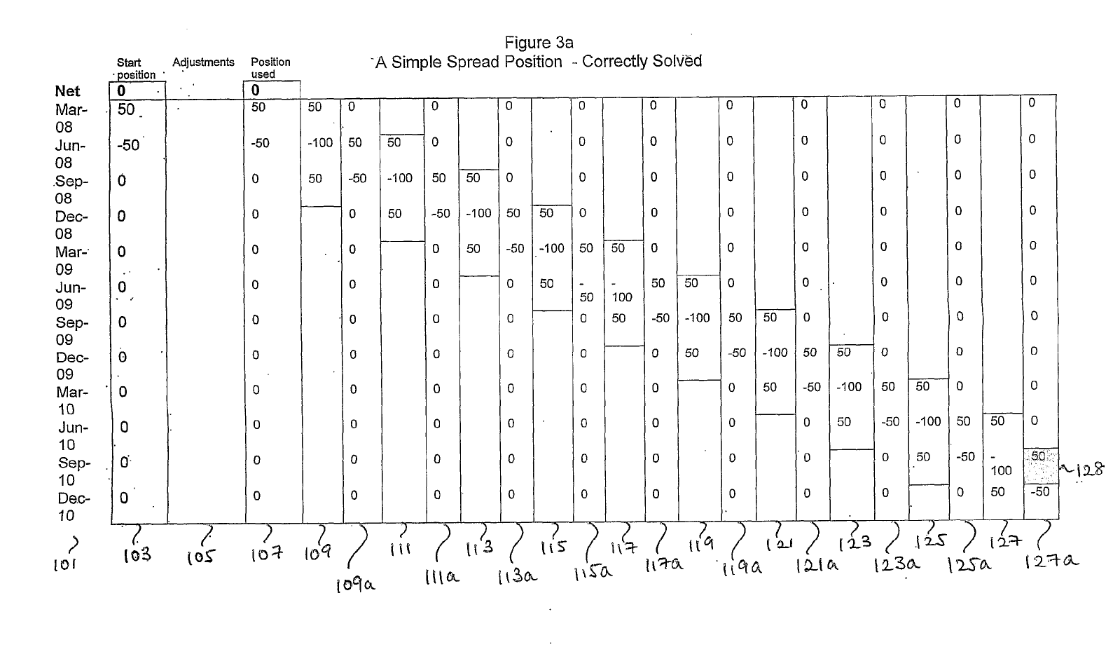

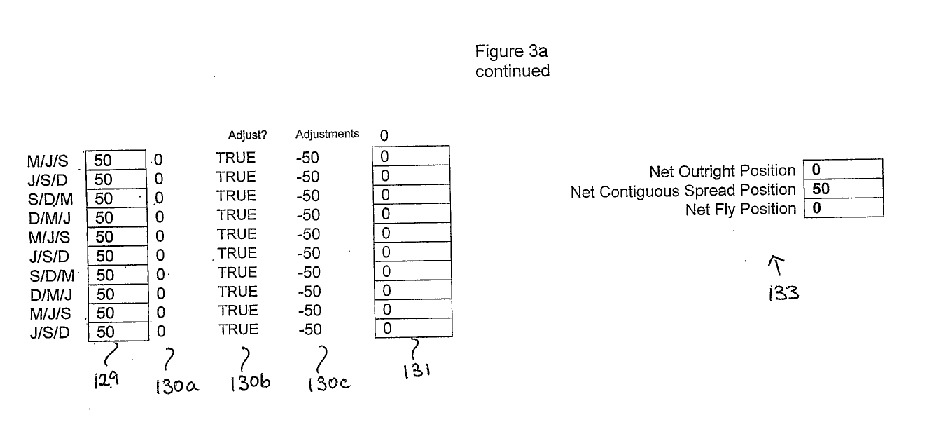

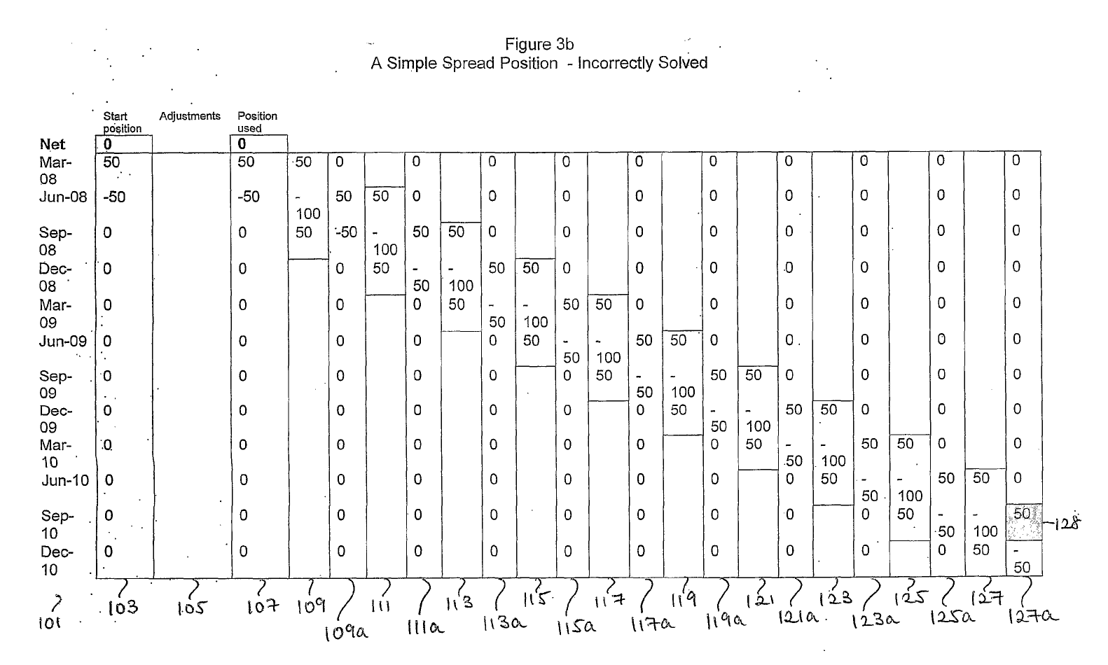

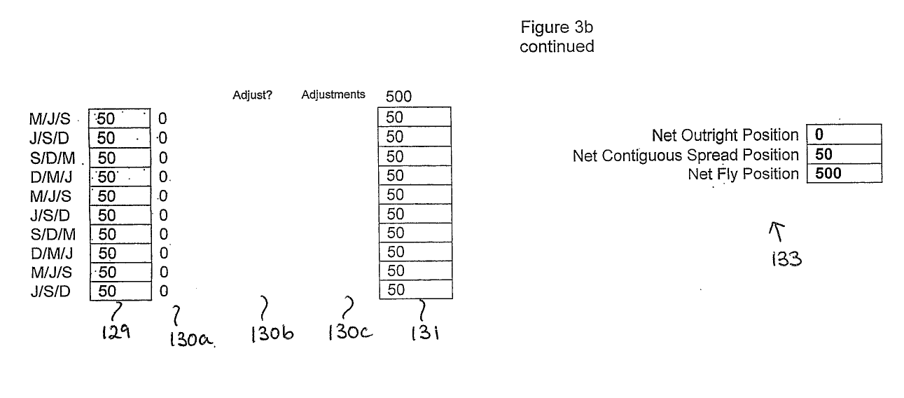

FIGS. 3a and 3b show the calculator used to resolve a simple spread position. In FIG. 3a, the calculator is used correctly. FIG. 3b shows the same position resolved incorrectly (i.e. without taking into account the adjustment for outstanding, left over spreads).

Note that column 105 is used to adjust for outstanding outrights (which do not form part of a spread or a butterfly). FIG. 3a shows how we adjust for outstanding spreads (which do not form part of a butterfly). Referring to FIG. 3a, column 103 shows a position of +50 Mar'08 outrights and −50 June'08 outrights. (This is clearly just +50 Mar'08June'08 spreads but let's see how the calculator can deal with this.)

Firstly, the total net position is zero so we do not need to make any adjustment in column 105, so that column is empty. Column 107 therefore contains the same position as column 103.

We have +50 Mar'08 outrights, so we must have +50 Mar'08June'08Sep'08 butterflies in column 109 (i.e. +50 Mar'08, −100 June'08, +50 Sep'08). The resulting position in column 109a is therefore +50 June'08 and −50 Sep'08. The Mar'08 position is zero.

We have +50 June'08 outrights in column 109a, so we must have +50 June'08Sep'08Dec'08 butterflies in column 111 (i.e. +50 June'08, −100 Sep'08, +50 Dec'08). The resulting position in column 111a is therefore +50 Sep'08 and −50 Dec'08. The Mar'08 and June'08 positions are zero.

We have +50 Sep'08 outrights in column 111a, so we must have +50 Sep'08Dec'08Mar'09 butterflies in column 113 (i.e. +50 Sep'08, −100 Dec'08, +50 Mar'09). The resulting position in column 113a is therefore +50 Dec'08 and −50 Mar'09. The Mar'08, June'08 and Sep'08 positions are zero.

We continue to perform these steps through columns 115, 117, 119, 121, 123, 125 and 127. The position listed in column 127a is +50 Sep'10 and −50 Dec'10.

As a result of the calculation, in table 129, we have 50 of each butterfly from Mar'08June'08Sep'08 to June'10Sep'10Dec'10. In column 127a, there is a value shown at location 128. In this example, the figure at location 128 is +50. This figure indicates whether we need to adjust for outstanding spreads: if the figure is zero, we do not need to adjust and the butterfly positions in table 129 are already correct; if the figure is non-zero, we need to adjust the positions in table 129 appropriately. Thus, the figure in position is equal to the number of spreads which do not form part of a butterfly.

So, in this case, we need to adjust for +50 spreads that do not form part of a butterfly and, in order to do this, we work back through the cascade (columns 127a back to column 109), or, looking at it more simply, work up the rows in table 129. So, we look at the bottom cell of table 129 (June'10Sep'10Dec'10 butterflies) and ask whether this is equal to the spread adjustment value in location 128 (in this case +50). In actual fact, this will always be equal to the value in location 128 because column 127a (and hence the bottom cell of table 129) simply indicates the position taking into account the June'10Sep'10Dec'10 butterflies in column 127. Sure enough, in this case, the bottom cell of table 129 equals +50. So, because the value here is equal to the value in location 128, it does need to be adjusted. Because this does need to be adjusted, we have “TRUE” under “Adjust?” in column 130b (this is equivalent to indicating that we do need to adjust) and a zero in column 130a. The adjustment (“Adjustments” in column 130c) is −50, which gives the resulting amount in 131 as 0.

Then, we work up through the table 129 doing the same thing. The number of March'10June'10Sep'10 butterflies (next row up in table 129) is also equal to +50, so we again have 0 in column 130a, TRUE in column 130b and −50 in column 130c, which gives us a resulting position of 0 in column 131.

We continue all the way up through table 129 removing the +50 wherever the value of butterflies in the appropriate cell of table 129 is equal to the value in location 128. In the case of FIG. 3a, all the butterfly values in table 129 are +50, so the resulting position in column 131 (and hence at 133) becomes zero butterflies.

Most examples are more complicated than the example of FIG. 3a and some more difficult examples will be discussed below.

Why the figure in location 128 is an accurate indication of the number of outstanding spreads will be discussed below.

FIG. 3b shows the same position, in which we ignore the figure in location 128, so make no adjustments for outstanding spreads. This gives us the resulting position in table 133 of Net Outright Position=0, Net Contiguous Spread Position=50 and Net Fly Position=500. Considering our original position in column 103, this is clearly incorrect and the resulting position in FIG. 3a is, instead, correct.

Thus, in this embodiment, we use the net position in column 103 to adjust for outrights and the figure at location 128 to adjust for spreads. Making these two adjustments gives us the correct position at table 133.

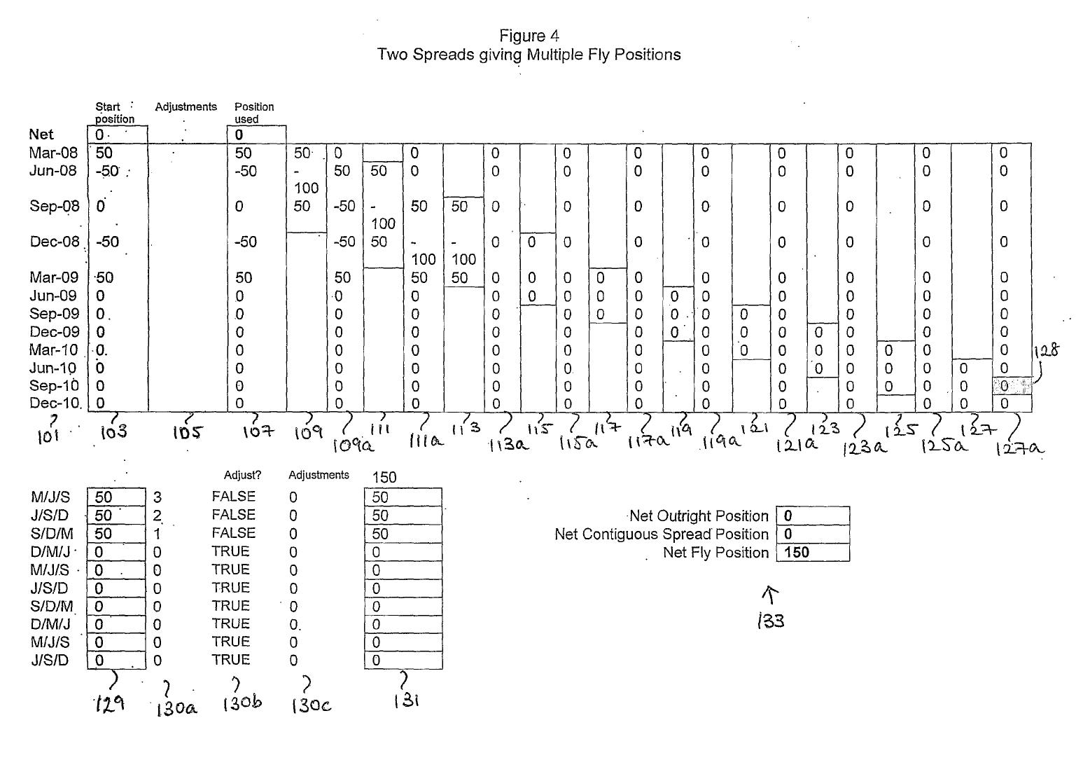

Now we discuss some examples. FIG. 4 shows how the calculator is used to resolve a position of two spreads, which gives a multiple fly position. The position in column 103 is +50 Mar'08, −50 June'08, −50 Dec'08 and +50 Mar'09. The net position of this is zero, so no adjustment is required in column 105. Running the position through the calculator gives a resulting butterfly position in table 129 of: +50 Mar'08June'08Sep'08, +50 June'08Sep'08Dec'08 and +50 Sep'08Dec'08Mar'09. The figure at position 128 is zero, so no spread adjustment is required to the position given in table 129. So the resulting position at 133 is Net Outright Position=0, Net contiguous Spread Position=0 and Net Fly Position=150.

In actual fact, we have shown, in FIG. 4, adjustments made in columns 130a, 130b and 130c, but this simply applies the previously described method, even though the value in location 128 is zero. Thus, the bottom 7 cells in table 129 are zero so no adjustment is needed here (column 130a contains 0, column 130b contains TRUE and column 130c contains adjustment of 0, for these cells). The Sep'08Dec'08Mar'09 cell equals +50. Since this is not equal to the value in location 128, no adjustment is needed here: the value in column 130a is non-zero, we have FALSE in column 130b (which indicates that we do not need to adjust) and we have 0 adjustment in column 130c. This is the same in the top two cells—no adjustment is needed, and the value in column 130a is non-zero, we have FALSE in column 130b and we have 0 adjustment in column 130c. Note that the value in column 130a is not important; it is simply the case that if the position needs adjusting, the value in column 130a is zero and, if it does not need adjusting, the value in column 130a is non-zero.

So, the resulting position in 133 is 150 butterflies: 50 Mar'08June'08Sep'08 butterflies, 50 June'08Sep'08Dec'08 butterflies and 50 Sep'08Dec'08Mar'09 butterflies. For this example, it is easy to show that this butterfly position is, indeed, equal to the outright position given in column 103:

$$\begin{matrix}\begin{matrix} + 50 {Mar}^{’} 08 June ’ 08 Sep ’ 08 = + 50 Mar ’ 08 June ’ 08 and \\ - 50 June ’ 08 Sep ’ 08 \\ = + 50 Mar ’ 08 and \\ - 50 June ’ 08 and \\ - 50 June ’ 08 and \\ + 50 Sep ’ 08 \\ = + 50 Mar ’ 08 and \\ - 100 June ’ 08 and \\ + 50 Sep ’ 08\end{matrix} & [ 6 ] \\ Similarly , & \\ + 50 June ’ 08 Sep ’ 08 Dec ’ 08 = + 50 June ’ 08 and - 100 Sep ’ 08 and + 50 Dec ’ 08 & [ 7 ] \\ And , & \\ + 50 Sep ’ 08 Dec ’ 08 Mar ’ 09 = + 50 Sep ’ 08 and - 100 Dec ’ 08 and + 50 Mar ’ 09 & [ 8 ]\end{matrix}$$

Summing together [6], [7] and [8] gives the result shown in Table 1:

TABLE 1

| | [6] | [7] | [8] | Total |
|---|---|---|---|---|
| Mar '08 | +50 | | | +50 |
| June '08 | −100 | +50 | | −50 |
| Sep '08 | +50 | −100 | +50 | 0 |
| Dec '08 | | +50 | −100 | −50 |
| Mar '09 | | | +50 | +50 |

This is exactly the same as the original outright position given in column 103 of FIG. 4.

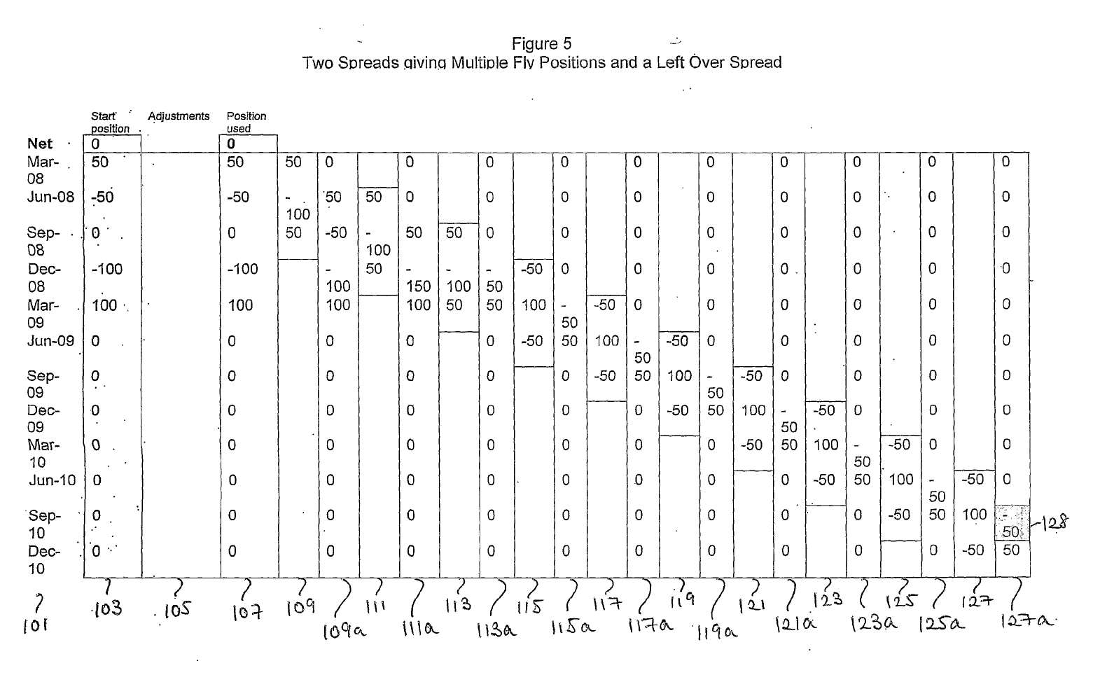

FIG. 5 shows how the calculator is used to resolve a position of two spreads, which gives a multiple fly position and a left over spread. This example is relatively easy to calculate. The position in column 103 is +50 Mar'08, −50 June'08, −100 Dec'08 and +100 Mar'09. The net position of this is zero, so no adjustment is required in column 105.

Running the position through the calculator gives a resulting butterfly position in table 129 of:

### +50 Mar'08June'08Sep'08,

### +50 June'08Sep'08Dec'08,

### +50 Sep'08Dec'08Mar'09,

### −50 Dec'08Mar'09June'09,

### −50 Mar'09June'09Sep'09,

### −50 June'09Sep'09Dec'09,

### −50 Sep'09Dec'09Mar'10,

### −50 Dec'09Mar'10June'10,

### −50 Mar'10June'10Sep'10 and

### −50 June'10Sep'10Dec'10.

However, the figure at position 128 is −50 so we need to make adjustment to the position in table 129. We do this using the method described above with reference to FIG. 3a.

Thus, first we look at the bottom cell (June'10Sep'10Dec'10) in table 129. This is equal to the value at location 128 (−50) so this needs to be adjusted. So, we have 0 in column 130a, TRUE in column 130b, and an adjustment of +50 in column 130c. Thus, the resulting number of June'10Sep'10Dec'10 butterflies in column 131 is 0.

Similarly, the next 6 cells upwards in table 129 are also equal to the location 128 value so are all adjusted appropriately.

But note that, when we reach the third cell of table 129 (Sep'08Dec'08Mar'09), the value here (+50) is not equal to the value at location 128 (−50). Thus no adjustment needs to be made to this value. So, there is a non-zero value in column 130a (in this case 1), a FALSE in column 130b and no adjustment in column 130c. The number of Sep'08Dec'08Mar'09 butterflies in column 131 remains 50. Similarly, when we reach the second cell of table 129 (June'08Sep'08Dec'08), the value here (+50) is not equal to the value at location 128 (−50). Thus no adjustment needs to be made to this value. So, there is a non-zero value in column 130a (in this case 1), a FALSE in column 130b and no adjustment in column 130c. The number of Sep'08Dec'08Mar'09 butterflies in column 131 remains 50.

Thus, column 131 gives us a corrected butterfly position of: +50 Mar'08June'08Sep'08, +50 June'08Sep'08Dec'08, +50 Sep'08Dec'08Mar'09. Thus, the resulting position at 133 is Net Outright Position=0, Net contiguous Spread Position=−50 and Net Fly Position=150.

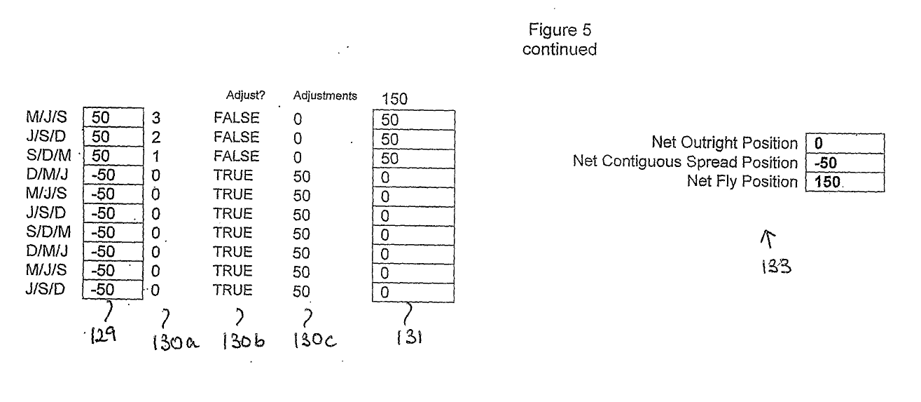

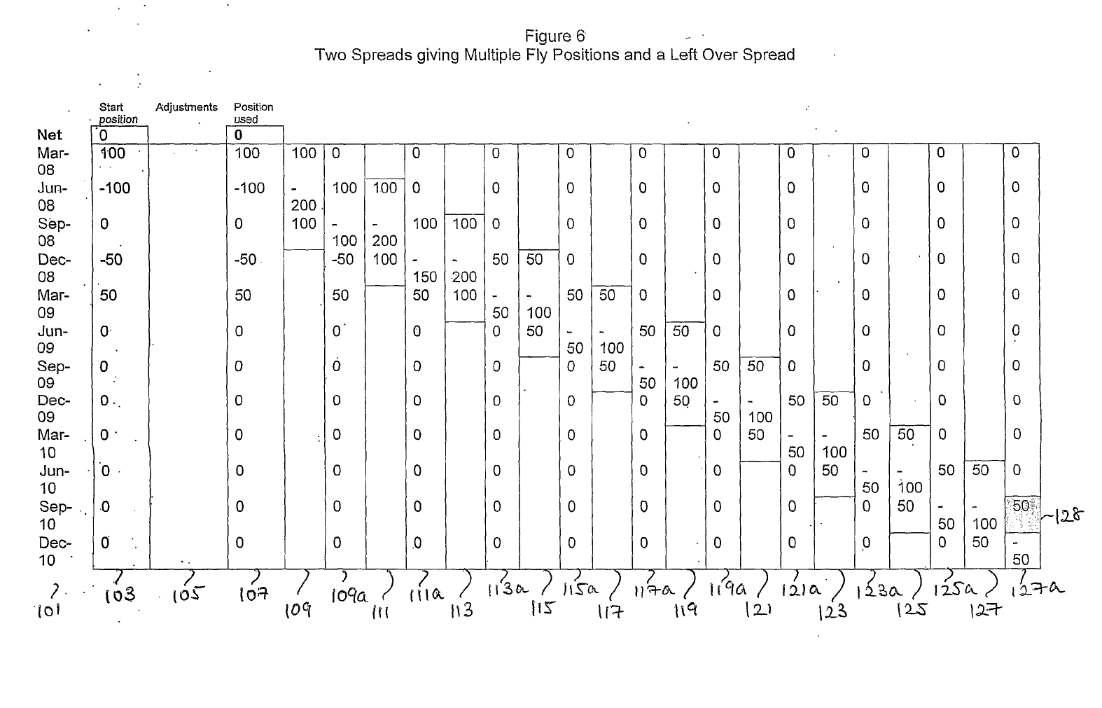

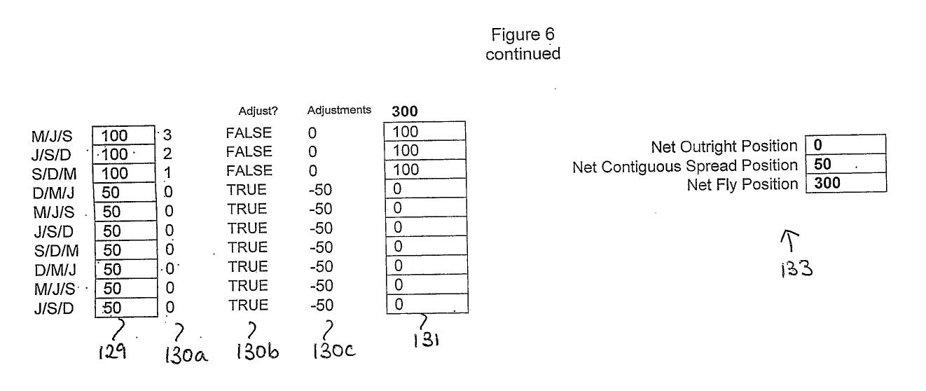

FIG. 6 is another example used to show how the calculator is used to resolve a position of two spreads, which gives a multiple fly position and a left over spread. This example is not as straightforward as the example given in FIG. 5 but still gives a good solution. The position in column 103 is +100 Mar'08, −100 June'08, −50 Dec'08 and +50 Mar'09. The net position of this is zero, so no adjustment is required in column 105.

Running the position through the calculator gives a resulting butterfly position in table 129 of:

### +100 Mar'08June'08Sep'08,

### +100 June'08Sep'08Dec'08,

### +100 Sep'08Dec'08Mar'09,

### +50 Dec'08Mar'09June'09,

### +50 Mar'09June'09Sep'09,

### +50 June'09Sep'09Dec'09,

### +50 Sep'09Dec'09Mar'10,

### +50 Dec'09Mar'10June'10,

### +50 Mar'10June'10Sep'10 and

### +50 June'10Sep'10Dec'10.

However, the figure at position 128 is +50 so we need to make adjustment to the position in table 129. As before, we compare the values in the cells in table 129 with the value at location 128, in this case +50, starting from the bottom cell (June'10Sep'10Dec'10).

The bottom 7 cells (June'10Sep'10Dec'10 back to Dec'08Mar'09June'09) all have values equal to +50, so all need to be adjusted. So, for all these cells, we have a 0 in column 130a, TRUE in column 130b and an adjustment of −50 in column 130c. This gives is a corrected position for these cells in column 131 of 0.

However, the top 3 cells (Sep'08Dec'08Mar'09, June'08Sep'08Dec'08 and Mar'08June'08Sep'08) all have values which are not equal to +50, so do not need to be adjusted. So, for these three cells, we have a non-zero value in column 130a, FALSE in column 130b and an adjustment of 0 in column 130c.

Thus, column 131 gives us a correct butterfly position of: +100 Mar'08June'08Sep'08, +100 June'08Sep'08Dec'08, +100 Sep'08Dec'08Mar'09. Thus, the resulting position at 133 is Net Outright Position=0, Net contiguous Spread Position=50 and Net Fly Position=300.

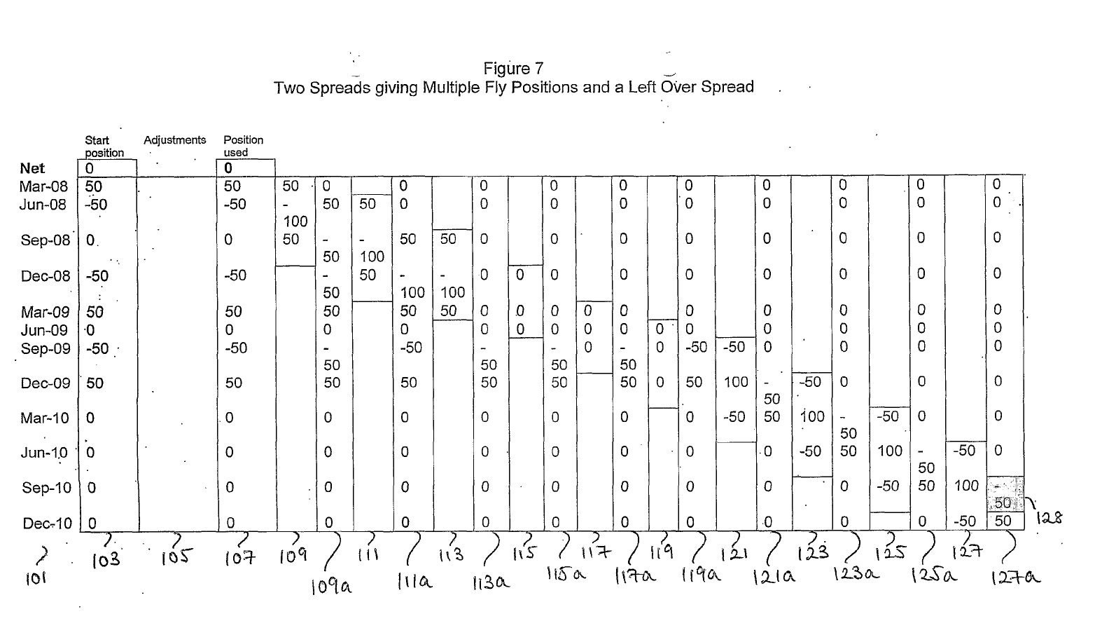

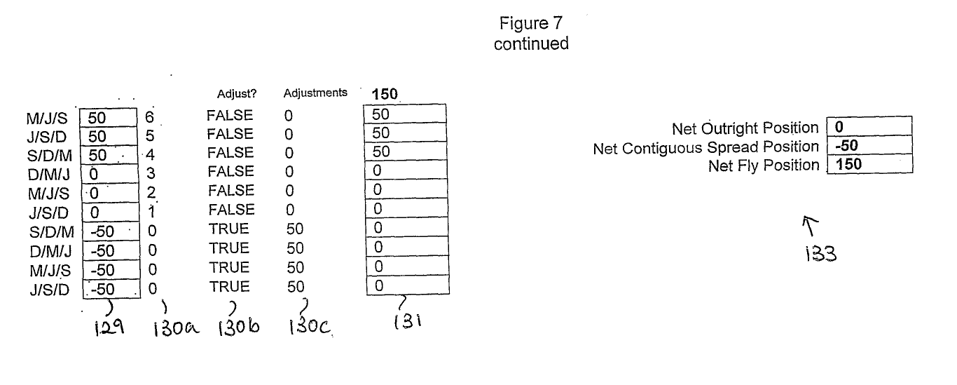

FIG. 7 is another example used to show how the calculator is used to resolve a position of two spreads, which gives a multiple fly position and a left over spread. This example is not as straightforward as the examples given in FIG. 5 or FIG. 6. The position in column 103 is +50 Mar'08, −50 June'08, −50 Dec'08, +50 Mar'09, −50 Sep'09 and +50 Dec'09. The net position of this is zero, so no adjustment is required in column 105.

Running the position through the calculator gives a resulting butterfly position in table 129 of:

### +50 Mar'08June'08Sep'08,

### +50 June'08Sep'08Dec'08,

### +50 Sep'08Dec'08Mar'09,

### 0 Dec'08Mar'09June'09,

### 0 Mar'09June'09Sep'09,

### 0 June'09Sep'09Dec'09,

### −50 Sep'09Dec'09Mar'10,

### −50 Dec'09Mar'10June'10,

### −50 Mar'10June'10Sep'10 and

### −50 June'10Sep'10Dec'10.

However, the figure at position 128 is −50 so we need to make adjustment to the position in table 129. As before, we compare the values in the cells in table 129 with the value at location 128, in this case −50, starting from the bottom cell (June'10Sep'10Dec'10).

The bottom 4 cells (June'10Sep'10Dec'10 back to Sep'09Dec'09Mar'10) all have values equal to −50, so all need to be adjusted. So, for all these cells, we have a 0 in column 130a, TRUE in column 130b and an adjustment of +50 in column 130c. This gives is a corrected position for these cells in column 131 of 0.

The next 3 cells (June'09Sep'09Dec'09 back to Dec'08Mar'09June'09) all have values equal to 0, which is different from the value in location 128 of −50. So, the vales in these cells do not need to be adjusted and, for these three cells, we have a non-zero value in column 130a, FALSE in column 130b and an adjustment of 0 in column 130c.

Similarly, the top 3 cells (Sep'08Dec'08Mar'09, June'08Sep'08Dec'08 and Mar'08June'08Sep'08) all have values which are not equal to −50, so do not need to be adjusted. So, for these three cells, we have a non-zero value in column 130a, FALSE in column 130b and an adjustment of 0 in column 130c.

Thus, column 131 gives us a correct butterfly position of: +50 Mar'08June'08Sep'08, +50 June'08Sep'08Dec'08, +50 Sep'08Dec'08Mar'09. Thus, the resulting position at 133 is Net Outright Position=0, Net contiguous Spread Position=−50 and Net Fly Position=150.

As discussed above, adjustments to account for left over outrights are made using column 105, to give a net zero position in column 107. In one method, the system, can automatically adjust the value of the last outright that was traded and keep doing this until the total number of outrights is zero. In another method, the trader manually inputs where he wishes to deduct the outrights (the idea being that the trader knows where he/she is most likely to trade to balance it). The deduction can be from one or more maturity dates. Or, a combination of these two methods may be used. For example, the trader can input an adjustment. If the total number of outrights is then zero, no further deduction need be made. But, if the total number of outrights is not zero, the system automatically makes a further adjustment (from the most recently traded outright or outrights) to bring the total number to zero.

In addition, spread adjustments are made using the value which is produced at location 128 after running the calculator. As shown in FIG. 3b, if we do not take account of left over spreads using the value at location 128, the resulting butterfly position may be incorrect. Ignoring the value at location 128 results in an overstated fly position.

The reason that the location 128 is important is that any spreads which are not accounted for by butterflies, will simply be propagated through the calculator and appear at the final available spread position—in this case Sep'10Dec'10 i.e location 128 and the cell below. Any spreads that can be accounted for in terms of butterflies, will be absorbed by the calculator and so will not appear in the final spread location.

The Automatic Fly calculator, according to an embodiment of the first aspect of the invention, described above, is used to convert an outright position into a position in terms of outrights, spreads and butterflies.

As already described, a second aspect of the invention provides a method for resolving a position of butterflies back into an outright position. Putting it another way, it is as if we are taking the position of column 131 in FIGS. 1 to 7 and working it backwards to an outright position like that in column 103. This is referred to as the Manual Fly Calculator.

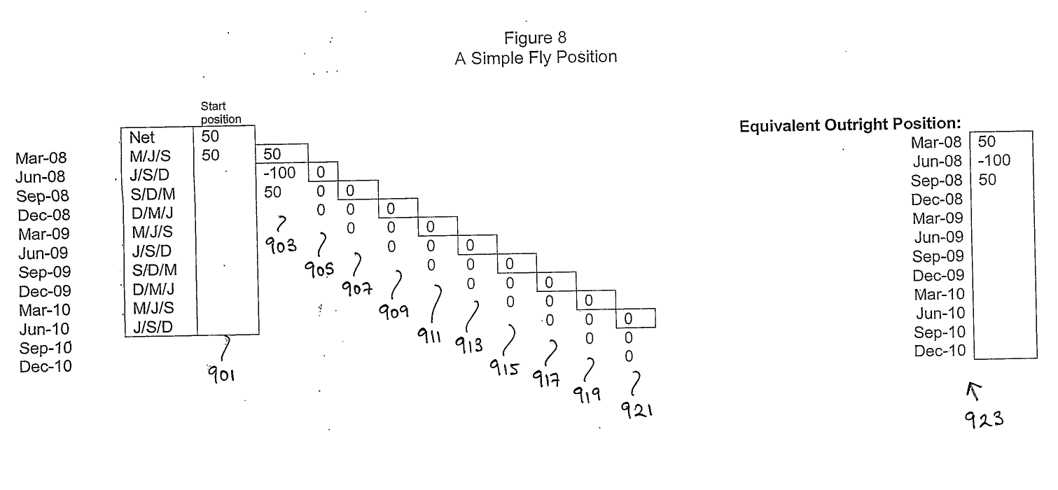

An embodiment of the second aspect of the invention will now be described with reference to FIGS. 8 to 11.

In the Manual Fly Calculator, we use the fact that a butterfly has the pattern +1, −2, +1 (or −1, +2, −1 for a sell of a fly) in terms of outrights. For example, a buy of a Mar'08June'08Sep'08 butterfly is:

| | |
|---|---|
| Mar '08 | +1 |
| June '08 | −2 |
| Sep '08 | +1 |

Thus, for every +1 Mar'08June'08Sep'08 butterfly, we have +1 Mar'08 outright, −2 June'08 outrights and +1 Sep'08 outright.

FIG. 8 shows a simple fly position in column 901. In this example, we only have +50 Mar'08June'08Sep'08 butterflies. In column 903, we convert this butterfly position into an outright position using the fact that a +1 butterfly is always equal to +1 of the first outright, −2 of the second outright and +1 of the third outright, as follows:

+1 butterfly of t₁, t₂ and t₃ (t₁, t₂ and t₃ being the three maturity dates associated with the butterfly) is equal to:
+1 spread of t₁,t₂ and −1 spread of t₂, t₃, which is equal to
+1 outright of t_{1, -1} outright of t_{2, -1} outright of t₂ and +1 outright of t₃, which is equal to:
+1 outright of t₁, −2 outright of t₂ and +1 outright of t₃
i.e. the +1, −2, +1 pattern. Of course, a −1 butterfly (selling rather than buying) would be equal to the −1, +2, −1 pattern.

So, the value entered for Mar'08June'08Sep'08 butterflies is +50. This gives the first leg of the fly as +50 Mar'08 outrights, the second leg of the fly as −100 (=−2×50) June'08 outrights and the third leg of the fly as +50 Dec'08 outrights. Therefore, this gives us in column 903 +50 Mar'08, −100 June'08 and +50 Sep'08. If further butterflies were included in the position of column 901, we would enter them in columns 903, 905, 907, 909, 911, 913, 915, 917, 919 and 921. Table 923 gives us the total number of outrights, obtained by adding together the outrights in each of the columns 903 to 921. Thus, in the FIG. 8 example, the total equivalent outright position is simply the total in column 903 i.e. +50 Mar'08, −100 June'08 and +50 Sep'08.

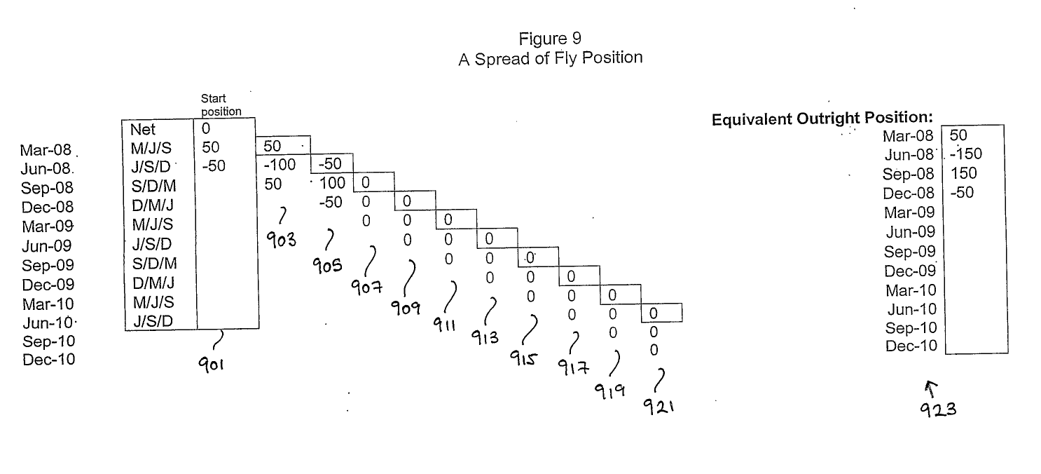

FIG. 9 shows a spread of fly position in column 901. In this example, we have +50 Mar'08June'08Sep'08 butterflies and −50 June'08Sep'08Dec'08 butterflies. The Mar'08June'08Sep'08 position is resolved in column 903, giving +50 Mar'08, −100 June'08 and +50 Sep'08 in column 903. The June'08Sep'08Dec'08 position is resolved in column 905, giving +50 June'08, −100 Sep'08 and +50 Dec'08. There are no later butterfly positions so columns 907 to 921 are empty. The equivalent outright position given in table 923 is therefore just the sum of column 903 and column 905 i.e. +50 Mar'08, −150 June'08, +150 Sep'08 and −50 Dec'08.

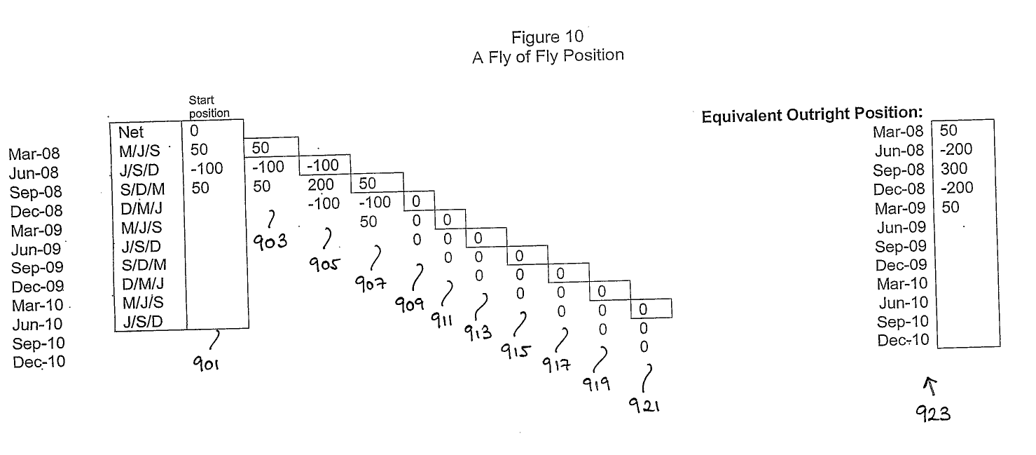

FIG. 10 shows a fly of fly position in column 901. In this example, we have +50 Mar'08June'08Sep'08 butterflies, −100 June'08Sep'08Dec'08 butterflies and +50 Sep'08Dec'08Mar'09 butterflies. The Mar'08June'08Sep'08 is resolved in column 903, giving +50 Mar'08, −100 June'08 and +50 Sep'08 in column 903. The June'08Sep'08Dec'08 position is resolved in column 905, giving −100 June'08, +200 Sep'08 and −100 Dec'08 in column 905. The Sep'08Dec'08Mar'09 is resolved in column 907, giving +50 Sep'08, −100 Dec'08 and +50 Mar'09 in column 907. There are no later butterfly positions so columns 909 to 921 are empty. The equivalent outright position given in table 923 is therefore just the sum of columns 903, 905 and 907 i.e. +50 Mar'08, −200 June'08, +300 Sep'08, −200 Dec'08 and +50 Mar'09.

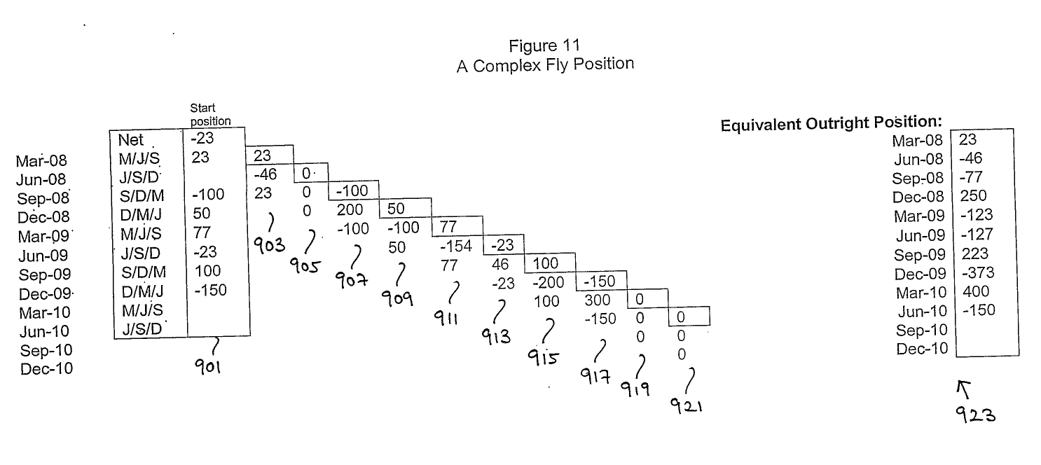

Finally, FIG. 11 shows a more complex butterfly position in column 901. In this example, we have +23 Mar'08June'08Sep'08 butterflies, 0 June'08Sep'08Dec'08 butterflies, −100 Sep'08Dec'08Mar'09 butterflies, +50 Dec'08Mar'09June'09 butterflies, +77 Mar'09June'09Sep'09 butterflies, −23 June'09Sep'09Dec'09 butterflies, +100 Sep'09Dec'09Mar'10 butterflies and −150 Dec'09Mar'10June'10 butterflies. Column 903 contains the resolved Mar'08June'08Sep'08 position, column 905 is empty since we have zero June'08Sep'08Dec'08 butterflies, column 907 contains the resolved Sep'08Dec'08Mar'09 position, column 909 contains the resolved Dec'08Mar'09June'09 position, column 911 contains the resolved Mar'09June'09Sep'09 position, column 913 contains the resolved June'09Sep'09Dec'09 position, column 915 contains the resolved Sep'09Dec'09Mar'10 position and column 917 contains the resolved Dec'09Mar'10June'10 position. The equivalent outright position given in table 923.

Thus, the Manual Fly Calculator as described with reference to FIGS. 8 to 11 allows a position in terms of butterflies to be converted to a position in terms of outrights.

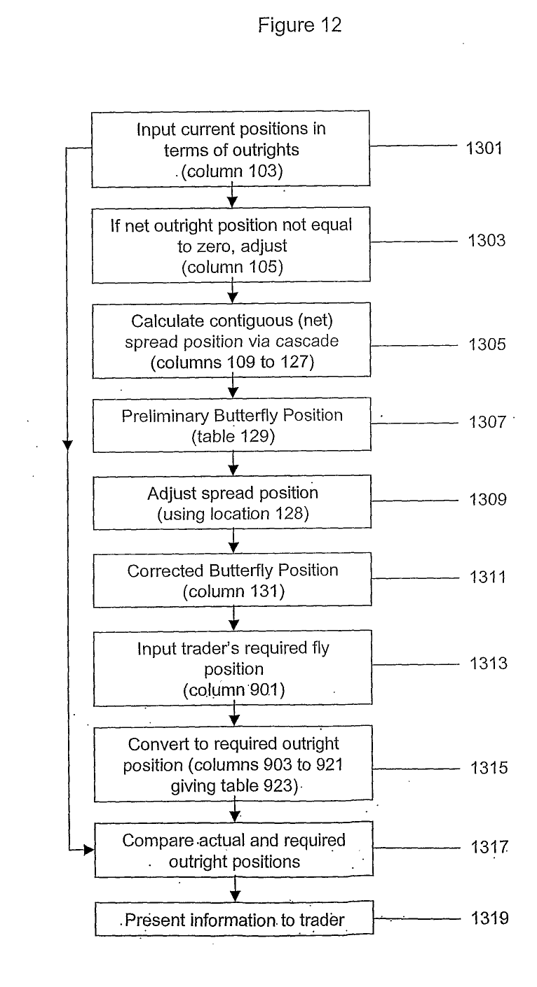

The Automatic Fly Calculator and the Manual Fly Calculator can be used together to continuously convert between one position and the other as the trader is trading and/or to indicate to the trader what trades he/she still needs to perform in order to reach a required position. FIG. 12 shows an example of the Automatic Fly Calculator and Manual Fly Calculator used together in practice.

At step 1301, the current positions in terms of outrights are input. This is the position listed in column 103 of the Automatic Fly Calculator.

At step 1303, an adjustment is made if the net outright position is zero. This is the column 105 adjustment, which produces the position in column 107.

At step 1305, the contiguous (net) spread positions are calculated by the cascade of the Automatic Fly Calculator. This is the cascade process of columns 109 to 127.

At step 1307, we reach the preliminary butterfly position of table 129.

At step 1309, the preliminary butterfly position of table 129 is adjusted according to the spread figure given at location 128.

At step 1311, we reach the corrected butterfly position of column 131.

At step 1313, the trader's required position in terms of butterflies is input. This is the position listed in column 901 of the Manual Fly Calculator.

At step 1315, the required fly position is converted to a required outright position. This is the process performed in columns 903 to 921 of the Manual Fly Calculator. We reach the required outright position of table 923.

At step 1317, the required outright position is compared to the actual outright position.

Finally, at step 1319, the information is presented to a trader so he/she can see what trades need to be made to resolve his/her position.

Now we use an example to work through the steps of FIG. 12.

Consider a current position entered at step 1301 of:

| | | |
|---|---|---|
| Mar '08 | +100 | |
| June '08 | −200 | |
| Sep '08 | 150 | |
| Dec '08 | −50 | [7] |

This has a net zero position in terms of outrights, so no adjustment is required at step 1303.

Using the Automatic Fly Calculator at step 1305, we reach a preliminary butterfly position at step 1307 of:

| | |
|---|---|
| Mar '08June '08Sep '08 | +100 |
| June '08Sep '08Dec '08 | 0 |
| Sep '08Dec '08Mar '09 | +50 |
| Dec '08Mar '09June '09 | +50 |
| Mar '09June '09Sep '09 | +50 |
| June '09Sep '09Dec '09 | +50 |
| Sep '09Dec '09Mar '10 | +50 |
| Dec '09Mar '10June '10 | +50 |
| Mar '10June '10Sep '10 | +50 |
| June '10Sep '10Dec '10. | +50 |

The value at location 128 is +50, so we adjust the spread position at step 1309 using that figure. This produces a corrected butterfly position of:

| | |
|---|---|
| Mar '08June '08Sep '08 | +100 |
| only. | |

Then, at step 1313, we enter the following required fly position:

| | |
|---|---|
| Mar '08June '08Sep '08 | +100. |

Then, we convert this to an outright position at step 1315. The resulting required outright position is:

| | | |
|---|---|---|
| Mar '08 | +100 | |
| June '08 | −200 | |
| Sep '08 | +100 | [8] |

Then, at step 1317, we compare the actual outright position at [7] with the required outright position at [8]. We find that the difference is +50 Sep'08 and −50 Dec'08.

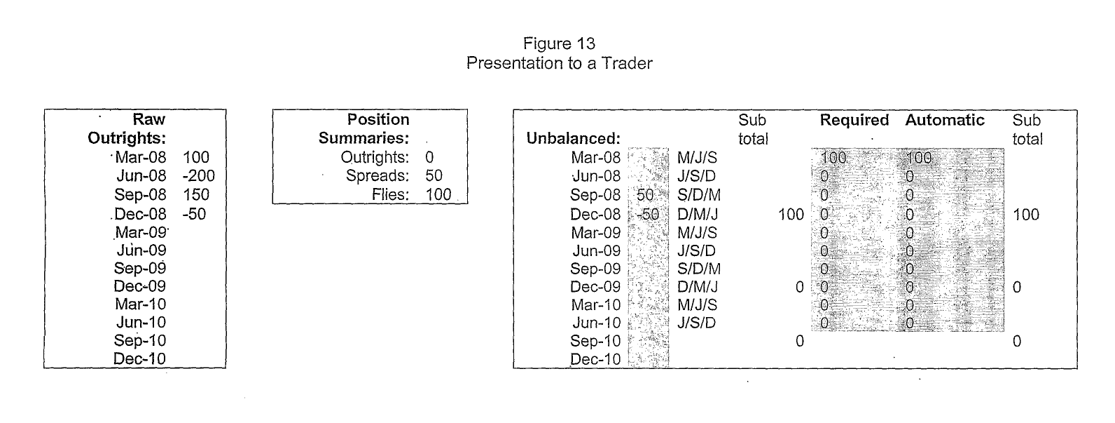

The information is then presented to the trader and one example of such a presentation (for this example) is shown in FIG. 13. In the example of FIG. 13, it can be seen that the trader is shown the initial outright position (“Raw Outrights”), the initial butterfly/spread/outright position (“Position Summaries”) and the number of butterflies required to achieve the required position (“Unbalanced”). Note that the “sub total” is the total for all four butterflies in one 12-month period (e.g. Mar'08 to Dec'08).

Thus, the Automatic Fly Calculator provides a method by which a complex outright position can be converted into a position in terms of butterflies, with outstanding outrights and spreads. These can be indicated to the trader, allowing the trader to manage his/her risk appropriately. The Manual Fly Calculator provides a method by which a fly position can be converted into a position in terms of outrights. Particularly useful is to convert a required fly position into a position in terms of outrights and compare against the current outright position. This allows the trader to easily and quickly manage his/her trading positions. The two calculators can be used in a number of ways, together or separately, to provide useful information to a trader. For example, we might have a current outright position and a required fly position. In that case, we can use the Automatic Fly Calculator to convert the current outright position to a current fly position, which can then be compared with the required fly position. And, we can use the Manual Fly Calculator to convert the required fly position to a required outright position, which can then be compared with the current outright position.

Or, we might have a current fly position and a required outright position. In that case, we can either use the Manual Fly Calculator to convert the current fly position to a current outright position, which can then be compared with the required outright position. Or, less useful in practice, but still possible, we can use the Automatic Fly Calculator to convert the required outright position to a required fly position, which can then be compared with the current fly position.

Any combination of these can be used continually as the trader trades and the required and current trading positions change, as they do, for example, in very fast moving markets.

Although the examples above have been described in connection with Short Sterling, the tool could be used for any futures contracts associated with a future maturity date.

1. A method for converting a trading position expressed in terms of futures contracts, each futures contract being associated with a maturity date, into a trading position expressed in terms of at least butterflies of futures contracts, each butterfly being associated with three maturity dates, the method comprising the steps of:
a) providing a trading position, expressed in terms of futures contracts, each futures contract being associated with a maturity date t, the trading position comprising n(t) contracts for each of m maturity dates, t₁ to tₘ, n being positive for futures contracts purchased and negative for futures contracts sold;
b) for the earliest maturity date t₁, converting the trading position into an interim trading position by subtracting n(t₁) contracts associated with maturity date t₁, −2n(t₁) contracts associated with maturity date t₂ and n(t₁) contracts associated with maturity date t₃, the total number of futures contracts subtracted together being equivalent to n(t₁) butterflies associated with maturity dates t₁, t₂ and t₃;
c) repeating step b) for maturity dates t₂ to tₘ₋₂, wherein each converting step b) converts the previous interim trading position into a new interim trading position, and each converting step b) comprises subtracting a number n(t) of butterflies;
d) extracting the number of butterflies subtracted, from the results at b) and c), to give a trading position expressed in terms of butterflies.

2. A method according to claim 1, wherein, if the trading position expressed in terms of futures contracts comprises a non-zero total number of futures contracts
$${\sum }_{{t}_{1}}^{{t}_{m}} n ( t ) ,$$
the method further comprises an initial step of subtracting the appropriate number of futures contracts to produce a contract-adjusted trading position expressed in terms of futures contracts, the contract-adjusted trading position having a total number of futures contracts
$${\sum }_{{t}_{1}}^{{t}_{m}} n ( t )$$
equal to zero.

3. A method according to claim 2, wherein the number of futures contracts subtracted from the trading position to produce the contract-adjusted trading position is included in the trading position expressed in terms of at least butterflies, as an additional number of futures contracts.

4. A method according to claim 1, further comprising the step of:
e) adjusting the trading position expressed in terms of butterflies derived at step d), to produce a spread-adjusted trading position, using the number n(tₘ₋₁) of futures contracts associated with maturity date tₘ₋₁ in the interim trading position derived from the final repetition of step b) in accordance with step c).

5. A method according to claim 4, wherein the trading position expressed in terms of butterflies derived at step d) comprises n_{b}(t) butterflies for each set of three consecutive maturity dates t₁t₂t₃ . . . tₘ₋₂tₘ₋₁tₘ and step e) of adjusting the trading position comprises comparing the number n(tₘ₋₁) with each number of butterflies n_{b}(t) and, if n(tₘ₋₁) is equal to n_{b}(t), subtracting n(tₘ₋₁) from n_{b}(t) and, if n(tₘ₋₁) is not equal to n_{b}(t), making no adjustment to n_{b}(t).

6. A method according to claim 5, wherein the step of comparing the number n(tₘ₋₁) with each number of butterflies n_{b}(t) comprises: comparing n(tₘ₋₁) with n_{b}(tₘ₋₂,tₘ₋₁,tₘ), then comparing n(tₘ₋₁) with n_{b}(tₘ₋₃,tₘ₋₂,tₘ₋₁) and so on until the step of comparing n(tₘ₋₁) with n_{b}(t₁,t₂,t₃).

7. A method according to claim 4, wherein the number n(tₘ₋₁) of futures contracts associated with maturity date tₘ₋₁ in the interim trading position derived from the final repetition of step b) in accordance with step c), is included in the trading position expressed in terms of at least butterflies, as an additional number of spreads of futures contracts.

8. A method for converting a trading position expressed in terms of futures contracts, each futures contract being associated with a maturity date, into a trading position expressed in terms of butterflies of futures contracts, spreads of futures contracts and futures contracts, each butterfly being associated with three maturity dates and each spread being associated with two maturity dates, the method comprising the steps of:
a) providing a trading position, expressed in terms of futures contracts, each futures contract being associated with a maturity date t, the trading position comprising n(t) contracts for each of m maturity dates, t₁ to tₘ, n being positive for futures contracts purchased and negative for futures contracts sold;
b) if the total number of futures contracts
$${\sum }_{{t}_{1}}^{{t}_{m}} n ( t )$$
in the trading position at a) is not equal to zero, subtracting the appropriate number of futures contracts from the trading position to produce a contract-adjusted trading position, the adjusted trading position having a total number of futures contracts
$${\sum }_{{t}_{1}}^{{t}_{m}} n ( t )$$
equal to zero;
c) for the earliest maturity date t₁, converting the contract-adjusted trading position into an interim trading position by subtracting n(t₁) contracts associated with maturity date t₁, −2n(t₁) contracts associated with maturity date t₂ and n(t₁) contracts associated with maturity date t₃, the total number of futures contracts subtracted together being equivalent to n(t₁) butterflies associated with maturity dates t₁, t₂ and t₃;
d) repeating step c) for maturity dates t₂ to tₘ₋₂, wherein each converting step c) adjusts the previous interim trading position into a new interim trading position, and each converting step c) comprises subtracting a number n(t) of butterflies;
e) extracting the number of butterflies subtracted, from the results at c) and d) to give a trading position expressed in terms of butterflies;
f) adjusting the trading position expressed in terms of butterflies derived at step e) to take account of spreads of futures contracts not included in a butterfly; and
g) deriving a trading position expressed in terms of butterflies of futures contracts, spreads of futures contracts and futures contracts from the number of butterflies in the adjusted trading position of step f), the number of spreads accounted for in step f) and the number of futures contracts accounted for in step b).

9. A method for converting a trading position expressed in terms of butterflies of futures contracts, each butterfly being associated with three maturity dates, into a trading position expressed in terms of futures contracts, each futures contracts being associated with a maturity date, the method comprising the steps of:
a) providing a trading position, expressed in terms of butterflies of futures contracts, each butterfly being associated with a first maturity date in the range t₁ to tₘ₋₂, a second maturity date in the range t₂ to tₘ₋₁ and a third maturity date in the range t₃ to tₘ, the trading position comprising n(t) butterflies for each first maturity date t₁ to tₘ₋₂, n being positive for butterflies purchased and negative for butterflies sold;
b) for the earliest first maturity date t₁, calculating the number of futures contracts equivalent to n(t₁) butterflies, wherein n(t₁) butterflies is equivalent to n(t₁) futures contracts associated with maturity date t₁, −2n(t₁) futures contracts associated with maturity date t₂ and n(t₁) futures contracts associated with maturity date t₃;
c) repeating step b) for first maturity dates t₂ to tₘ₋₂; and
d) summing the number of futures contracts for each maturity date derived from steps b) and c) to give a trading position expressed in terms of futures contracts.

10. A method of providing information to a trader, the method comprising the steps of:
a) converting a current trading position expressed in terms of futures contracts into a current trading position expressed in terms of at least butterflies of futures contracts, according to the method of claim 1;
b) comparing the current trading position derived at step a) with a required trading position expressed in terms of butterflies of futures contracts; and
c) indicating to the trader the purchases and sales of butterflies of futures contracts and/or spreads of futures contracts and/or futures contracts, needed to turn the current trading position into the required trading position.

11. A method of providing information to a trader, the method comprising the steps of:
a) converting a required trading position expressed in terms of futures contracts into a required trading position expressed in terms of at least butterflies of futures contracts, according to the method of claim 1;
b) comparing the required trading position derived at step a) with a current trading position expressed in terms of butterflies of futures contracts; and
c) indicating to the trader the purchases and sales of butterflies of futures contracts and/or spreads of futures contracts and/or futures contracts, needed to turn the current trading position into the required trading position.

12. A method of providing information to a trader, the method comprising the steps of:
a) converting a current trading position expressed in terms of butterflies of futures contracts into a current trading position expressed in terms of futures contracts, according to the method of claim 9;
b) comparing the current trading position derived at step a) with a required trading position expressed in terms of futures contracts; and
c) indicating to the trader the purchases and sales of futures contracts, needed to turn the current trading position into the required trading position.

13. A method of providing information to a trader, the method comprising the steps of:
a) converting a required trading position expressed in terms of butterflies of futures contracts into a required trading position expressed in terms of futures contracts, according to the method of claim 9;
b) comparing the required trading position derived at step a) with a current trading position expressed in terms of futures contracts; and
c) indicating to the trader the purchases and sales of futures contracts, needed to turn the current trading position into the required trading position.

14. A method according to claim 10, wherein step c) comprises displaying information to the trader on a trader user interface.

15. A method of providing information to a trader, the method comprising the steps of:
a) converting a current or required trading position expressed in terms of futures contracts, each futures contract being associated with a maturity date, into a current or required trading position expressed in terms of at least butterflies of futures contracts, each butterfly being associated with three maturity dates, by: i) providing the current or required trading position, expressed in terms of futures contracts, each futures contract being associated with a maturity date t, the trading position comprising n(t) contracts for each of m maturity dates, t₁ to tₘ, n being positive for futures contracts purchased and negative for futures contracts sold; ii) for the earliest maturity date t₁, converting the current or required trading position into an interim trading position by subtracting n(t₁) contracts associated with maturity date t₁, −2n(t₁) contracts associated with maturity date t₂ and n(t₁) contracts associated with maturity date t₃, the total number of futures contracts subtracted together being equivalent to n(t₁) butterflies associated with maturity dates t₁, t₂ and t₃; iii) repeating step ii) for maturity dates t₂ to tₘ₋₂, wherein each converting step ii) converts the previous interim trading position into a new interim trading position, and each converting step ii) comprises subtracting a number n(t) of butterflies; and iv) extracting the number of butterflies subtracted, from the results at ii) and iii), to give a current or required trading position expressed in terms of butterflies;
b) comparing the current or required trading position derived at step a) with a required trading position expressed in terms of butterflies of futures contracts; and
c) indicating to the trader the purchases and sales of butterflies of futures contracts and/or spreads of futures contracts and/or futures contracts, needed to turn the current or required trading position into the required or current trading position.

16. (canceled)

17. A method of providing information to a trader, the method comprising the steps of:
a) converting a current or required trading position expressed in terms of butterflies of futures contracts, each butterfly being associated with three maturity dates, into a current or required trading position expressed in terms of futures contracts, each futures contracts being associated with a maturity date, by: i) providing the current or required trading position, expressed in terms of butterflies of futures contracts, each butterfly being associated with a first maturity date in the range t₁ to tₘ₋₂, a second maturity date in the range t₂ to tₘ₋₁ and a third maturity date in the range t₃ to tₘ, the trading position comprising n(t) butterflies for each first maturity date t₁ to tₘ₋₂, n being positive for butterflies purchased and negative for butterflies sold; ii) for the earliest first maturity date t₁, calculating the number of futures contracts equivalent to n(t₁) butterflies, wherein n(t₁) butterflies is equivalent to n(t₁) futures contracts associated with maturity date t₁, −2n(t₁) futures contracts associated with maturity date t₂ and n(t₁) futures contracts associated with maturity date t₃; iii) repeating step ii) for first maturity dates t₂ to tₘ₋₂; and iv) summing the number of futures contracts for each maturity date derived from steps ii) and iii) to give a current or required trading position expressed in terms of futures contracts;
b) comparing the current or required trading position derived at step a) with a required trading position expressed in terms of futures contracts; and
c) indicating to the trader the purchases and sales of futures contracts, needed to turn the current or required trading position into the required or current trading position.

18. (canceled)

19. Apparatus specially adapted to carry out the method of claim 1.

20. A computer program which, when run on computer means, causes the computer means to carry out the method of claim 1.

21. A record carrier having stored thereon a computer program which, when run on computer means, causes the computer means to carry out the method of claim 1.
